(19) United States
(12) Patent Application Publication
(10) Pub. No.: US 2003/0037003 A1
(43) Pub. Date: Feb. 20, 2003

(54) ERushes rights

(76) Inventors: Gillian Elizabeth Parker, Washington, DC (US); Neil John Simpson, Southfields (GB)

Correspondence Address: Gillian Parker, 1652 29th St NW, Washington, DC, 20007, US

(21) Appl. No.: 09/930,614

(22) Filed: Aug. 16, 2001

(51) Int. Cl. G06F 17/60

(52) U.S. Cl. 705/51

(57) ABSTRACT

ERushes rights ensures that only the right content reaches the correct legally allowed buyers. It gives content owners control over who buys their footage, by matching the right buyers with the right content rights. It's a simple idea, but aims to stop problems before they start, and not frustrate buyers with tempting them with content they are not able to buy.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO A MICROFICHE APPENDIX

Not Applicable

### BACKGROUND OF THE INVENTION

“ERushes Rights” is all about safeguarding rights to content. It is particularly designed to do so on the internet and in the digital arena. This is the problem: How do you guard rights to content in a digital market place?

Traditionally rights have been protected by content owners because they have sold within clubs, selling only to whom they know, slowly, with very inefficient human contracts, phone calls and personal contacts.

Selling content digitally changes all that. Taking content to new buyers makes it harder to control and know exactly whom you are selling to.

“ERushes rights” solves this problem.

The issue of rights is extremely complex. Content owners own bits and pieces of rights to content, for instance based on geography, time and type of use, among other criteria. A content owner may own the rights to sell content or footage to the States but not to Europe. They may want to sell rights for 3 years or 5 years or forever. They may only be able to sell rights to cable channels, not broadcasters or educational establishments. They may want to charge different users different amounts of money for the same content—for instance allowing non profit organizations cheaper access than to advertisers for the same content.

So how do you control the digital distribution of footage taking into account, location, time, type of buyer and other criteria? Making sure that the right people buy the right content or footage? And only the content or footage they are allowed by law to buy?

“ERushes Rights” has a solution, which ensures that content goes only to the buyers who are eligible to buy it. This is not about encryption, but about a process which sifts and ensures that only the right buyers can view content, and then ensures that only the right content goes to the right buyer.

### BRIEF SUMMARY OF THE INVENTION

The Solution: This process is designed to ensure that only the right footage or content reaches a buyer who is allowed to buy it in a digital marketplace.

“ERushes rights” rests on the concept that footage is only retrieved to view if the buyer's registered profile matches the rights metadata attached to the footage. A buyer may only buck this by emailing for an exception. It ensures that criteria including but not excluding other criteria, such as geographical rights, how the material will be used, and for how many days or months or years the material will be used. It gives the content owner/seller control over who they want to know about and buy the content. The owner can choose their buyers if they want, in effect recreating the old club of the traditional market. But it also gives content owners the comfort to know they can shut out unwanted buyers, even in a larger market.

At the moment the digital market place is in its infancy. And so far we have only seen that people want to rely on encryption for control of content. But that won't work, because it is too late. Once a piece of content has gone to the wrong buyer, even if you know whom that buyer is, most content owners do not have the means nor money to pay for lawyers to chase up that content, particularly if it is in a far away country.

“ERushes Rights” aims to stop content before it goes to the wrong place. Rather than chasing it afterwards. It's a simple system, but is a major improvement on what is out there now.

### BRIEF DESCRIPTION OF THE SEVERAL VIEWS OF THE DRAWING

Not Applicable

### DETAILED DESCRIPTION OF THE INVENTION

The Process:

1. When the content is digitized it is tagged with metadata which includes data on the rights issues, for instance, which countries it can be sold to, can it be used on broadcast or cable or for public meetings, for how many months or days or years may this license last for, among other criteria.

2. When a buyer logs onto the website for the first time, the buyer has to register, not just their name and address and contact details, but also the geographical location of where their business is run from, among other information. A buyer has to also give details of a credit card or bank account from which the buyer will draw money and funds to pay for the content.

3. When the buyer searches for footage, the search engine checks where the buyer is located geographically, and does not retrieve any footage to show the buyer if those rights are no longer available for that buyer's geographical area. Sluice gates in effect shut off the footage to that buyer's view.

4. The same sluice gate system will also work for advertising, broadcast or whatever —no footage which is only for sale for broadcast will then be shown to an advertiser for example, thus diminishing the risk of footage going to an unlicensed “unallowed” buyer.

5. The same sluice gate system can shut off access to view and the potential for wrong sales for any criteria which is needed.

6. If a buyer is buying footage for a production outside their own geographical location the buyer has to obtain an exemption from the (eRushes) system in order to open up the sluice gates.

7. The search results will also be able to display any restrictions on the length of time footage may be used, and any other more unusual restrictions on the use of the footage.

8. A buyer may also do an advanced rights search to cut out unwanted footage from appearing on their initial search, if the buyer already has very specific rights needs.

9. The buyer has to agree to an online contract, before the footage is delivered.

What we claim as our invention is

1. A system which operates sluice gates to stop content buyers from seeing or knowing about any content they are not allowed to buy

2. a system which stops content going out to the wrong buyers rather than the present systems which simply tell content owners where their content has wrongly gone to

3. a system which gives content owners the ability to control who buys their content

4. a system which stops the content reaching ineligible buyers in the digital market place.
